(19) United States
(12) Patent Application Publication
(10) Pub. No.: US 2026/0208322 A1
(43) Pub. Date: Jul. 23, 2026

(54) MULTI-PURPOSE SHARPENER

(71) Applicant: Mighty Dreams LLC, Fremont, CA (US)

(72) Inventor: Salma Baig, Freemont, CA (US)

(21) Appl. No.: 19/032,026

(22) Filed: Jan. 18, 2025

(51) Int. Cl. B24D 15/08; B67B 7/16; F23Q 1/06; G01C 17/04

(52) U.S. Cl. CPC B24D 15/08; B67B 7/16; F23Q 1/06; G01C 17/04

(57) ABSTRACT

The present disclosure relates to a multi-purpose sharpener device comprising a body, a sharpening plate holder that can be attached in multiple orientations, a spark generating rod, a sharpening rod, a whistle, a compass, and a bottle opener. In some embodiments, the pull-through sharpeners are integrated into the body, optionally covered by a selectively openable lid. The sharpening plate holder supports interchangeable sharpening plates or a strop. By consolidating essential outdoor and survival functions with a robust sharpening system, the device offers convenience, versatility, and reduced weight for field or everyday applications. The spark generating rod, compass, and whistle further facilitate fire starting, navigation, and emergency signaling, respectively. The bottle opener adds everyday utility.

### TECHNICAL FIELD

The present invention relates generally to handheld blade sharpening devices. More particularly, it concerns a multi-functional sharpener that integrates various sharpening components such as pull-through sharpeners, removable sharpening plates, a sharpening rod, and a strop. The multi-functional sharpener additionally integrates outdoor and survival tools such as a spark-generating rod, a whistle, a compass, and a bottle opener.

### BRIEF SUMMARY OF THE INVENTION

The multi-purpose sharpener is configured to perform a variety of blade maintenance tasks while also offering several essential tools for outdoor or everyday use. The sharpener includes a body housing one or more pull-through sharpeners arranged in slots, a sharpening plate holder that can be removably attached in different orientations, and a sharpening rod particularly suited for serrated knives and fish hooks. The sharpening plate holder is designed to receive sharpening plates (e.g., coarse or fine plates) and a strop, all of which can be interchanged or locked into place to accommodate different sharpening needs.

The sharpener further incorporates additional functionalities within the same housing to address common field or survival tasks. A spark-generating rod (or “spark rod”) provides a reliable method of igniting tinder, while a whistle enables audible signaling in emergency situations. A built-in compass aids in basic navigation, and a bottle opener allows users to remove standard bottle caps. By combining these elements into a single unit, the multi-purpose sharpener reduces the need to carry separate tools and ensures that critical features remain readily accessible.

In use, a user can draw a knife blade through the pull-through sharpeners for quick edge maintenance or employ the sharpening rod for specialized tasks, such as honing serrated edges or sharpening fish hooks. For more thorough blade reconditioning, the user can remove and reposition the sharpening plate holder to utilize coarse, fine, or strop surfaces. The spark rod, compass, whistle, and bottle opener further expand the device's functionality, making it ideal for camping, hiking, and everyday applications.

### BRIEF DESCRIPTION OF THE DRAWINGS

The invention will be readily understood by the following detailed description in conjunction with the accompanying drawings, in which like reference numerals designate like structural elements, and in which:

FIG. 1 is a perspective view of the multi-purpose sharpener with a sharpening plate holder in a first position and detached from the body;

FIG. 2 is a perspective view of the multi-purpose sharpener with the sharpening plate holder in a second position so that the sharpening plate is exposed for use;

FIG. 3 is a perspective view of the multi-purpose sharpener with the sharpening plate holder partially inserted into the body in the second position;

FIG. 4 is a perspective view of the multi-purpose sharpener with a sharpening rod in an extended position;

FIG. 5 is a perspective view of the multi-purpose sharpener with a spark generating rod in an extended position;

FIG. 6 is a perspective view illustrating the pull-through sharpeners of the multi-purpose sharpener being used to sharpen a knife, with the pull-through sharpener lid in an open position; and

FIG. 7 is a perspective view illustrating the bottle opener of the multi-purpose sharpener being used to open a bottle.

The drawings described herein are provided for illustrative purposes and are not intended to limit the scope of the present disclosure in any way.

### DETAILED DESCRIPTION

In the following description, to better understand the aforementioned purposes, features, and advantages of the present invention, numerous specific details are set forth in order to provide a thorough understanding of the claimed subject matter. It should be noted that these details and examples are provided to merely aid in understanding the descriptions, and they do not, in any way, limit the scope of the present invention. The present invention can also be implemented in other modes different from those described herein and the present invention is not limited to the specific embodiments disclosed below.

The specification may refer to “an”, “one” or “some” embodiment(s) in several locations. This does not necessarily imply that each such reference is to the same embodiment(s), or that the feature only applies to a single embodiment. A single feature of different embodiments may also be combined to provide other embodiments.

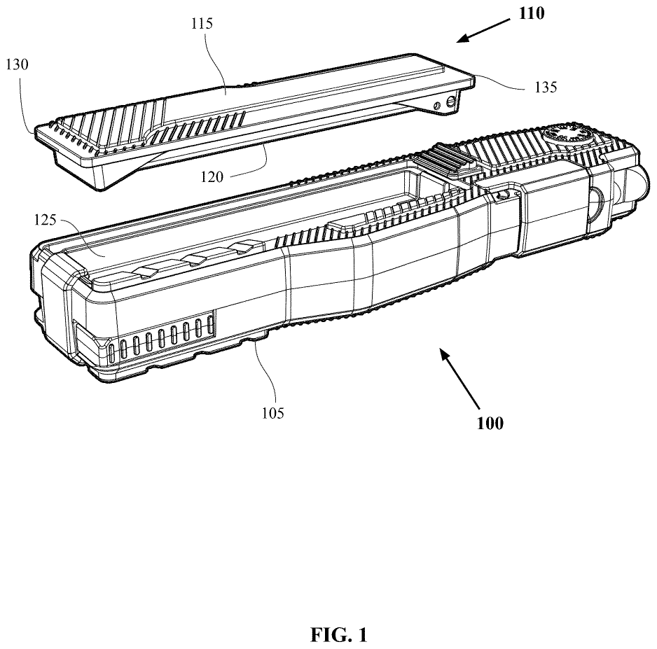

Referring to FIG. 1, a multi-purpose sharpener 100 is shown with a body or housing 105 and a sharpening plate holder 110 detached in a first position. In some embodiments, the first position of the sharpening plate holder functions as a stowing or protective orientation, where no sharpening plate is exposed to the outside. This configuration helps prevent accidental contact with the abrasive surfaces and preserves the plate's condition when not actively being used.

The sharpening plate holder 110 includes a first side 115 and an opposing second side 120, the second side being configured to accommodate an abrasive surface, and a sharpening plate holder cavity 125 for receiving the sharpening plate holder. The sharpening plate holder 110 further includes a first end 130 and a second end 135.

In some embodiments, the sharpening plate holder 110 can be attached to or removed from the body 105 by sliding or snapping it into place, depending on user preference or maintenance needs.

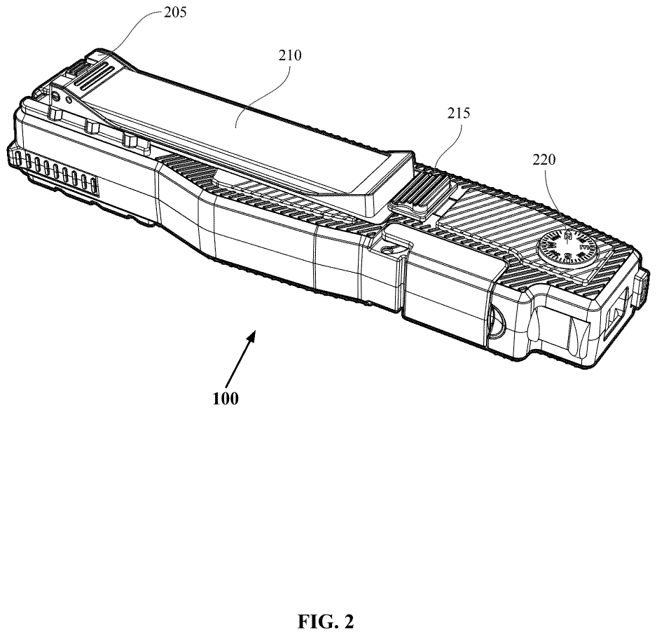

Referring now to FIG. 2, the sharpening plate holder 110 is shown in a second position such that a sharpening plate 210 of the one or more sharpening plates is exposed for use. The one or more sharpening plates can include, but are not limited to, diamond plates, ceramic plates, carbide plates, aluminum oxide stones, natural stones, waterstones, and various strops (e.g., leather, felt, or synthetic).

In some embodiments, a sharpening plate lock 205 may be used to secure or release the selected sharpening plate 210 (e.g., coarse, fine, or strop). A sharpening plate holder lock 215 can be engaged by a user to affix the holder 110 in the chosen orientation of either first side 115 facing outward or second side 120 facing outward. Additionally, the multi-purpose sharpener 100 may incorporate a compass 220 on or within the body 105, enabling basic directional guidance.

In some embodiments, the sharpening plate holder cavity 125 is dimensioned to store the one or more sharpening plates when the sharpening plate holder 110 is attached to the body 105.

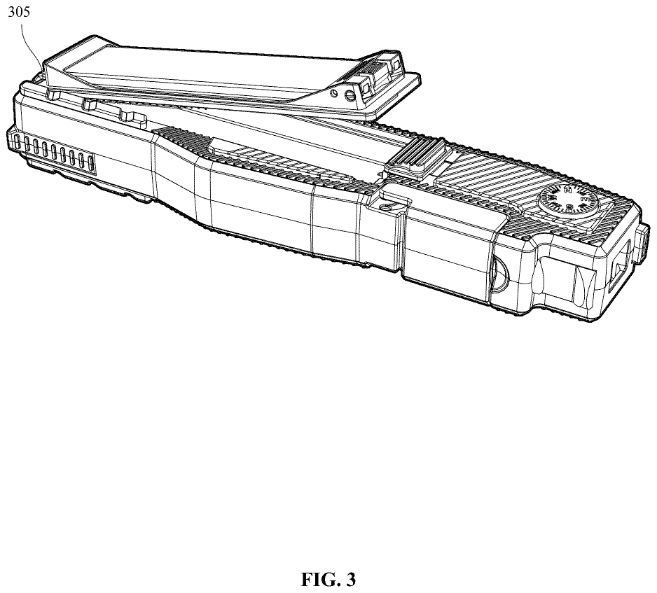

FIG. 3 illustrates a sharpening plate holder insertion slot 305 that is sized and shaped to receive and affix one end of the sharpening plate holder 110. When inserting or removing the sharpening plate holder 110, the user aligns it with the insertion slot 305 and locks it in place via the sharpening plate holder lock 215. This modular configuration allows users to flip or change the sharpening surfaces quickly and securely.

In some embodiments, the user can align either the first end 130 or the second end 135 of the sharpening plate holder 110 with the insertion slot 305. By choosing which end to insert into the slot, the user can determine which end of the sharpening plate holder is oriented towards the end of the body. This arrangement allows quick reconfiguration of the sharpening surface without needing additional tools for the purpose of promoting even wear across the surface. Rotating the sharpening plate helps ensure that the same area of the plate does not receive all the contact from the blade, which helps maintain a more level and consistent sharpening surface over time.

In other embodiments, different connection systems can be used to removably attach the sharpening plate holder onto the body including, but not limited to, magnetic retention systems, friction-fit couplings, twist-lock fasteners, detent pin mechanisms, hinged clamps, snap-fit assemblies with spring-loaded latches, or quick-release clamps (not shown).

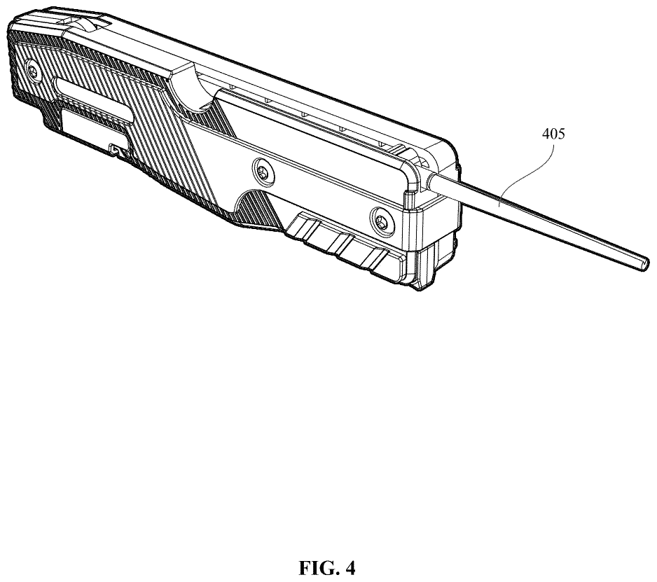

In FIG. 4, the multi-purpose sharpener 100 is depicted with a sharpening rod 405 in an extended position. The sharpening rod 405 is particularly suited for honing serrated knife edges, fish hooks, or other applications requiring a narrower abrasive surface. It may be stored within the body 105 when not in use and extended outward by rotating the rod. In other embodiments, the sharpening rod 405 may be engaged by pushing, pulling, or engaging a release mechanism (not shown).

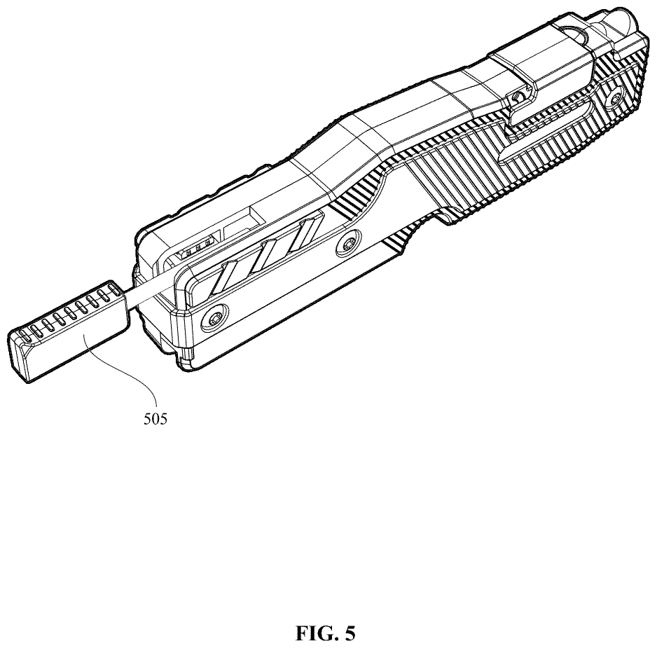

As shown in FIG. 5, a spark generating rod 505 (e.g., ferrocerium rod) can also be extended or otherwise accessed from the multi-purpose sharpener 100. The user can scrape this rod with the spine of a blade or a dedicated metal striker to produce sparks for fire-starting, making it valuable for outdoor or survival scenarios.

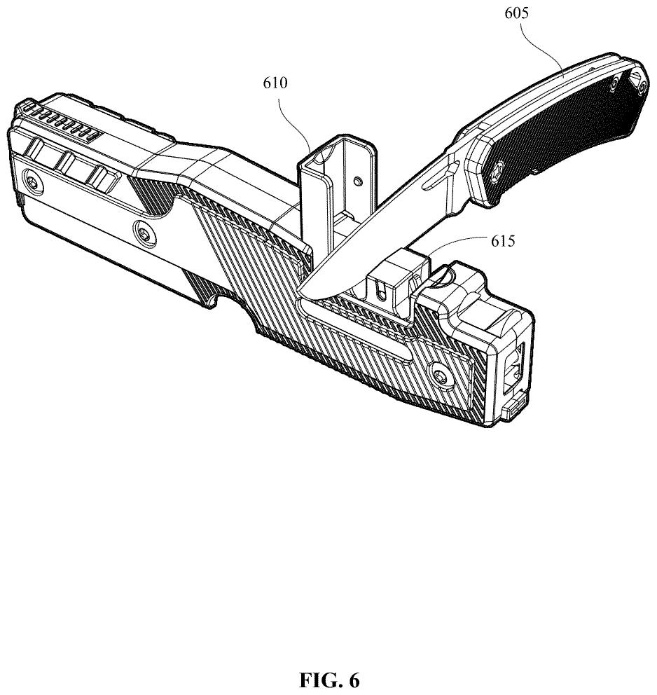

FIG. 6 demonstrates how the multi-purpose sharpener 100 may include one or more pull-through sharpeners 615. In some embodiments, the one or more pull-through sharpeners 615 are covered by a pull-through sharpener lid 610 when not in use. A user can insert a knife 605 into these slots, applying steady, uniform pressure in a single direction to quickly refresh or refine the blade edge. The pull-through sharpener lid 610 can be selectively opened or closed to protect the sharpening slots from debris or accidental contact.

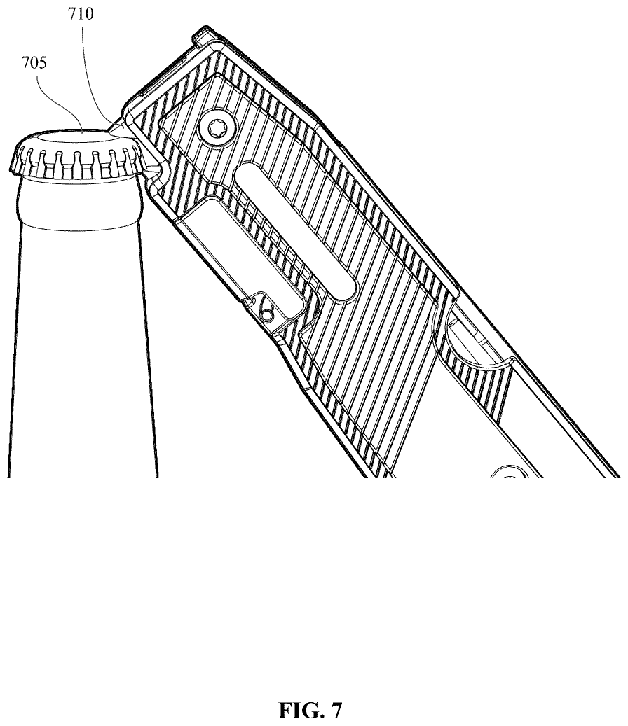

Finally, FIG. 7 illustrates a bottle 705 being opened using a bottle opener 710 that is integrated into the body 105 of the multi-purpose sharpener 100. The bottle opener 710 may be located at a convenient location on the housing to accommodate standard bottle caps.

In some embodiments, any of the sharpening elements employed in the invention (such as the sharpening plates, rods, or pull-through sharpeners) may be provided in various grit levels (e.g., coarse, medium, fine, or extra-fine) to enable progressive sharpening from initial shaping to final polishing, thereby allowing a user to achieve an optimal cutting edge for a range of blade types and conditions.

In practice, a user can carry the multi-purpose sharpener 100 as a compact kit for blade maintenance and general outdoor tasks. As depicted in the figures, the body 105 houses multiple functional components, including the pull-through sharpeners 615, the sharpening rod 405, and the spark generating rod 505, while the sharpening plate holder 110 enables interchangeable plates 210. The compass 220, bottle opener 710, and other features provide additional utility in both everyday and field environments. This integrated design addresses the need for versatile, lightweight, and space-saving equipment for campers, hikers, and individuals seeking a comprehensive sharpening and survival tool.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

I claim:

1. A multi-purpose sharpener, comprising:
a body; and
a sharpening plate holder having a first side and an opposing second side, the second side being configured to receive a sharpening plate, and further having a first end and an opposing second end;
wherein the sharpening plate holder is removably attachable to the body.

2. The multi-purpose sharpener of claim 1, wherein the sharpening plate holder is configured to be removably attachable to the body in a first position where the first side of the sharpening plate holder is exposed and a second position where the second side of the sharpening plate holder is exposed.

3. The multi-purpose sharpener of claim 2, further comprising a sharpening plate holder locking mechanism configured to be engageable by a user to removably attach the sharpening plate holder to the body in the first or second position.

4. The multi-purpose sharpener of claim 3, further comprising one or more sharpening plates, wherein the sharpening plate holder further comprises a sharpening plate locking mechanism configured to be engageable by a user to receive and hold at least one of the one or more sharpening plates.

5. The multi-purpose sharpener of claim 4, wherein the sharpening plate holder is further configured to be inserted into the body with either the first end or the second end being proximate to the end of the body.

6. The multi-purpose sharpener of claim 4, wherein the body further comprises a sharpening plate holder cavity that is dimensioned to store the one or more sharpening plates when the sharpening plate holder is attached to the body.

7. The multi-purpose sharpener of claim 6, further comprising a spark generating rod.

8. The multi-purpose sharpener of claim 7, wherein the spark generating rod is extendable from the body.

9. The multi-purpose sharpener of claim 6, further comprising one or more pull-through sharpeners integrated into the body.

10. The multi-purpose sharpener of claim 9, wherein the body further comprises a pull-through sharpener lid configured to selectively cover the one or more pull-through sharpeners.

11. The multi-purpose sharpener of claim 6, further comprising a compass.

12. The multi-purpose sharpener of claim 6, further comprising a selectively accessible whistle.

13. The multi-purpose sharpener of claim 6, further comprising a selectively accessible sharpening rod.

14. The multi-purpose sharpener of claim 6, further comprising a bottle opener.

15. A multi-purpose sharpener, comprising:
a body;
a sharpening plate holder having a first side and an opposing second side;
a sharpening plate holder locking mechanism;
one or more sharpening plates;
a spark generating rod;
one or more pull-through sharpeners;
a compass;
a whistle;
a sharpening rod; and
a bottle opener.

16. The multi-purpose sharpener of claim 15, wherein:
the sharpening plate holder is configured to be removably attachable to the body in a first position where the first side of the sharpening plate holder is exposed to the outside and a second position where the second side of the sharpening plate holder is exposed to the outside;
the sharpening plate holder locking mechanism is configured to be engageable by a user to removably attach the sharpening plate holder to the body in the first or second position; and
the sharpening plate holder further comprises a sharpening plate locking mechanism configured to be engageable by a user to receive and hold at least one of the one or more sharpening plates.

17. The multi-purpose sharpener of claim 16, wherein the body further comprises a sharpening plate holder cavity that is dimensioned to store the one or more sharpening plates when the sharpening plate holder is attached to the body.

18. The multi-purpose sharpener of claim 17, wherein:
the spark generating rod is extendable from the body; and
the body further comprises a pull-through sharpener lid configured to selectively cover the one or more pull-through sharpeners.

19. The multi-purpose sharpener of claim 17 wherein the sharpening plate holder is further configured to be inserted into the body with either the first end or the second end being proximate to the end of the body.

20. The multi-purpose sharpener of claim 17 wherein the majority of the external surface of the body is grooved.
